(19) United States
(12) Patent Application Publication
(10) Pub. No.: US 2005/0228554 A1
(43) Pub. Date: Oct. 13, 2005

(54) Control apparatus for hybrid vehicle

(75) Inventors: Akihiro Yamamoto, Utsunomiya-shi (JP); Hirokatsu Amanuma, Utsunomiya-shi (JP); Kazuhisa Yamamoto, Utsunomiya-shi (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/100,582

(22) Filed: Apr. 7, 2005

(30) Foreign Application Priority Data
Apr. 12, 2004 (JP) 2004-116759

(51) Int. Cl. G06F 17/00

(52) U.S. Cl. 701/22; 180/65.3

(57) ABSTRACT

A control apparatus for a hybrid vehicle that includes front and rear wheels, a battery, a first driving source that drives one of the front and the rear wheels, a second driving source that drives the other of the front and the rear wheels, the second driving source being operated by an electric energy stored in an electricity storing unit, an electric motor that collects a kinetic energy during deceleration of the vehicle to charge the electricity storing unit, includes: a deceleration state detecting unit that detects a deceleration state of the vehicle; a turning state detecting unit that detects a turning state of the vehicle, wherein a regenerated power by the electric motor is calculated according to the deceleration state detected by the deceleration state detecting unit and the turning state detected by the turning state detecting unit, and the electric motor is controlled according to the regenerated power.

### BACKGROUND OF THE INVENTION

1. Field of the Invention

The present invention relates to a control apparatus for a hybrid vehicle that drives one of the front or the rear wheels with a first driving source, and drives the other of the front or the rear wheels with an electric motor that is capable of being regenerated.

Priority is claimed on Japanese Patent Application No. 2004-116759, filed Apr. 12, 2004, the content of which is incorporated herein by reference.

2. Description of Related Art

In recent years, a hybrid vehicle is known in which primary driving wheels, one of the front or the rear wheels, are driven by an engine and auxiliary driving wheel, the other of the front or the rear wheels, are driven by a motor connected to a battery.

In such a hybrid vehicle, the engine and the motor are properly employed according to driving conditions, which contributes to a reduction in fuel consumption and emission gas.

There is a type of hybrid vehicle that converts braking energy back into electricity with one or more motors to use the energy for subsequent acceleration, thereby improving fuel efficiency. Another type of hybrid vehicle uses such regenerated energy for traveling only with the motor for further improving fuel efficiency.

For example, a technique for maneuvering stability of a four-wheel drive hybrid vehicle during a turning driving by prohibiting to change driving force allocation between the front wheels and the rear wheels is disclosed in Japanese Unexamined Patent Application, First Publication No. H09-284911.

Furthermore, a technique to control behavior of a vehicle is disclosed in Japanese Unexamined Patent Application, First Publication No. H10-184415 that includes a behavior control unit that electronically controls at least one of power sources for driving the vehicle (for example, an engine and an electric motor) and wheel brakes. During the control by the behavior control unit, switching between the power sources are prohibited to prevent a reduction accuracy of control of the behavior control unit.

Conventionally, one type of hybrid vehicle, full-time or real-time four-wheel drive vehicles are known which are provided with a motor to either the rear shaft or the front and the rear shafts of a vehicle having a conventional engine for providing four wheel drive, thereby improving both fuel efficiency and maneuvering performance.

In conventional full-time four-wheel drive vehicles, the allocation ratio of driving force is controlled according to traveling conditions of the vehicle, rather than changing the allocation ratio of the driving force of the wheels or switching between from two-wheel drive to four-wheel drive upon slipping. Therefore, in order to maintain an excellent maneuvering performance when the vehicle is turning in the full-time four-wheel drive vehicle, maneuverability during a turn can be maintained by switching the allocation ratio from a rear-wheel-oriented allocation in which more driving force is provided to the rear wheels for acceleration to an allocation according to the weight for increasing turning stability for maintaining stability during a turn.

Furthermore, in conventional real-time four-wheel drive vehicles, during turning acceleration, if rear wheels slip to enter a counter state, the vehicle becomes almost on the front-engine front wheel (FF) driving if the driver releases the accelerator pedal. In this case, the vehicle operates to restore traction of the rear wheels.

In contrast to the above-described techniques, in a hybrid vehicle that includes motors for the front and the rear wheels for driving of the vehicle and regeneration of power using the motors, it is desired to retain maneuvering stability during a turn and to restore traction of the real-time four-wheel driving while maintaining driving and regeneration by the continuing full-time four-wheel drive vehicle.

### SUMMARY OF THE INVENTION

The present invention was conceived in view of the above-described background, and, an object of the present invention is to provide a control apparatus for a hybrid vehicle for controlling allocation of the driving force between the front and the rear wheels during a turn, thereby improving fuel consumption, power, as well as maneuvering stability.

A first aspect of the present invention is a control apparatus for a hybrid vehicle that includes front and rear wheels; a battery; a first driving source that drives one of the front and the rear wheels, a second driving source that drives the other of the front and the rear wheels, the second driving source being operated by an electric energy stored in an electricity storing unit, an electric motor that collects a kinetic energy during deceleration of the vehicle to charge the electricity storing unit, including a deceleration state detecting unit that detects a deceleration state of the vehicle; a turning state detecting unit that detects a turning state of the vehicle, wherein a regenerated power by the electric motor is calculated according to the deceleration state detected by the deceleration state detecting unit and the turning state detected by the turning state detecting unit, and the electric motor is controlled according to the regenerated power.

According to this aspect, the regenerated power by the electric motor is calculated according to the deceleration state detected by the deceleration state detecting unit and the turning state detected by the turning state detecting unit. By this, allocation of the driving force between the front and the rear wheels during a turn is controlled so as to maintain maneuvering stability during the turn, thereby improving fuel consumption.

In a second aspect of the present invention, the vehicle may include a steering unit, and the turning state detecting unit may include a steering angle detecting unit that detects a steering angle of the steering unit, and the regenerated power by the electric motor may be decreased as the steering angle detected by the steering angle detecting unit is increased to the direction to which the steering angle rotates.

According to this aspect, it can be determined that the turning motion of the vehicle is required to be increased when the steering angle detected by the steering angle detecting unit is increased. Thus, the driving force that is required for the turning request can be supplied by decreasing the regenerated power by the electric motor to reduce the braking force, thereby enhancing the driving performance while improving fuel efficiency. Here, an increase in the steering angle in the direction to which the steering angle rotates means an increase in the steering angle to the direction corresponding to the direction in which the vehicle is turning.

Accordingly, if the steering angle is increasing in the clockwise direction while the vehicle is turning clockwise, this is assumed as an increase in the steering angle to the direction to which the steering angle rotates. In contrast, if the steering angle is increasing in the counterclockwise direction, this is not assumed as an increase in the steering angle to the direction to which the steering angle rotates.

In a third aspect of the present invention, the electric motor may drive the rear wheels, and the regenerated power by the electric motor may be set to zero when the steering angle detected by the steering angle detecting unit is increased to a predetermined value or greater.

According to this aspect, the braking force by the electric motor can be set to zero by setting the regenerated power by the electric motor to zero when the steering angle is increased to the predetermined value or greater. Thus, the driving force of the vehicle is utilized for a turning motion in a most effective manner, thereby further improving maneuverability.

In a fourth aspect of the present invention, when the steering angle is decreased after the regenerated power by the electric motor is decreased with an increase in the steering angle detected by the steering angle detecting unit, the regenerated power by the electric motor may be set to a regenerated power at a maximum detected steering angle.

According to this aspect, since the regenerated power by the electric motor is set to a regenerated power at the maximum detected steering angle when the steering angle is decreased, the braking force generated by the electric motor can be maintained to constant. Therefore, a turning motion can be carried out without causing discomfort to the driver, thereby enhancing maneuverability while improving fuel efficiency.

In a fifth aspect of the present invention, when the vehicle begins to travel straight ahead from a turn, the regenerated power by the electric motor may be no more set to the regenerated power at the maximum detected steering angle.

According to this aspect, the braking force of the electric motor can be increased when the vehicle begins to travel straight ahead from a turn without causing drift to the direction of the maneuvering of the vehicle. Thus, the regenerated power can be set according to the deceleration status of the vehicle, thereby improving fuel consumption while maintaining a good driving performance.

In a sixth aspect of the present invention, the turning state detecting unit may determine the turning state of the vehicle based on the steering angle and an operation direction of the steering unit and a yaw rate.

According to this aspect, since the turning state of the vehicle is determined based on the traveling condition of the vehicle in addition to the turning request, the turning state of the vehicle can be determined with a high accuracy. Thus, the electric motor can be controlled based on the determined turning state.

The first aspect of the present invention can improve all of fuel consumption, power, and maneuvering stability.

The second aspect of the present invention can enhance the driving performance while improving fuel efficiency.

The third aspect of the present invention enables the driving force of the vehicle to be utilized for a turning motion in a most effective manner, thereby further improving maneuverability.

The fourth aspect of the present invention enables a turning motion to be carried out without causing discomfort to the driver, thereby enhancing maneuverability while improving fuel efficiency.

The fifth aspect of the present invention can set the regenerated power according to the deceleration status of the vehicle, thereby improving fuel consumption while maintaining a good driving performance.

The sixth aspect of the present invention can determine the turning status of the vehicle, which enables control of the electric motor according to the determined turning condition.

### BRIEF DESCRIPTION OF THE DRAWINGS

FIG. 1 is a schematic diagram of a four-wheel drive hybrid vehicle to which the present invention is applied;

FIG. 2 is a schematic diagram of another four-wheel drive hybrid vehicle to which the present invention is applied;

FIG. 3 is a schematic diagram of another four-wheel drive hybrid vehicle to which the present invention is applied;

FIG. 4 is a schematic diagram of another four-wheel drive hybrid vehicle to which the present invention is applied;

FIG. 5 is a block diagram of the ECU included in the hybrid vehicles shown in FIGS. 1 to 4;

FIG. 6 is a flowchart of a main control executed by the hybrid vehicles shown in FIGS. 1 to 4;

FIG. 7 is a flowchart of the deceleration control shown in FIG. 6;

FIG. 8 is a flowchart of the rear regeneration allocation ratio hold control shown in FIG. 7;

FIG. 9 is a flowchart of the counter state determination control shown in FIG. 8;

FIG. 10 is a graph illustrating the relationship between the vehicle speed and the coasting drag;

FIG. 11 is a graph illustrating the relationship between the vehicle speed and the braking force;

FIG. 12 is a graph illustrating the relationship between the vehicle speed and the steering angle correction coefficient;

FIG. 13 is a graph illustrating the relationship between the lateral acceleration and the counter correction coefficient;

FIG. 14 is graph illustrating the change of the lateral acceleration of the vehicle and the steering angle over time;

FIG. 15A and 15B are diagrams illustrating examples of the steering angle and the lateral acceleration; and

FIG. 16 is graph illustrating the change of the vehicle speed, the steering angle, and the ratio to allocate braking force to the rear wheels over time.

### DETAILED DESCRIPTION OF THE INVENTION

Hereinafter, a control apparatus for a hybrid vehicle according to embodiments of the present invention will be described with reference to the drawings.

FIG. 1 is a schematic diagram of an exemplary hybrid vehicle 1a (1) to which the present invention is applied.

The hybrid vehicle 1a shown in FIG. 1 is a four-wheel drive vehicle that includes an engine E and a motor M2 in the front side of the vehicle, and a motor M1 that is connected to the an input of the differential gear D in the rear side. In this embodiment, the motor M1 in the rear side primarily functions as a generator, and the motor M2 in the front side primarily functions as a traction motor.

In this example, the motor M2 is positioned between the engine E and a transmission T having a clutch for the transmission (the transmission may be an automatic transmission). Furthermore, the clutch for the transmission (not shown) is provided that mechanically connects or disconnect the driving force output from the engine E or the motor M2 at the motor side end in the transmission T. A mechanical oil pump 21 is provided to supply working pressure to the clutch for the transmission. The mechanical oil pump 21 operates by driving the motor M2.

The hybrid vehicle 1a includes a starting clutch C between the motor M1 and the differential gear D that mechanically disconnects or connects the driving force output from the motor M1.

Thus, the output of the engine E and the motor M2 in the front side is transmitted to the front wheels Wf via the transmission T, the output of the motor M1 in the rear side is transmitted to the rear wheels Wr via the clutch C and the differential gear D.

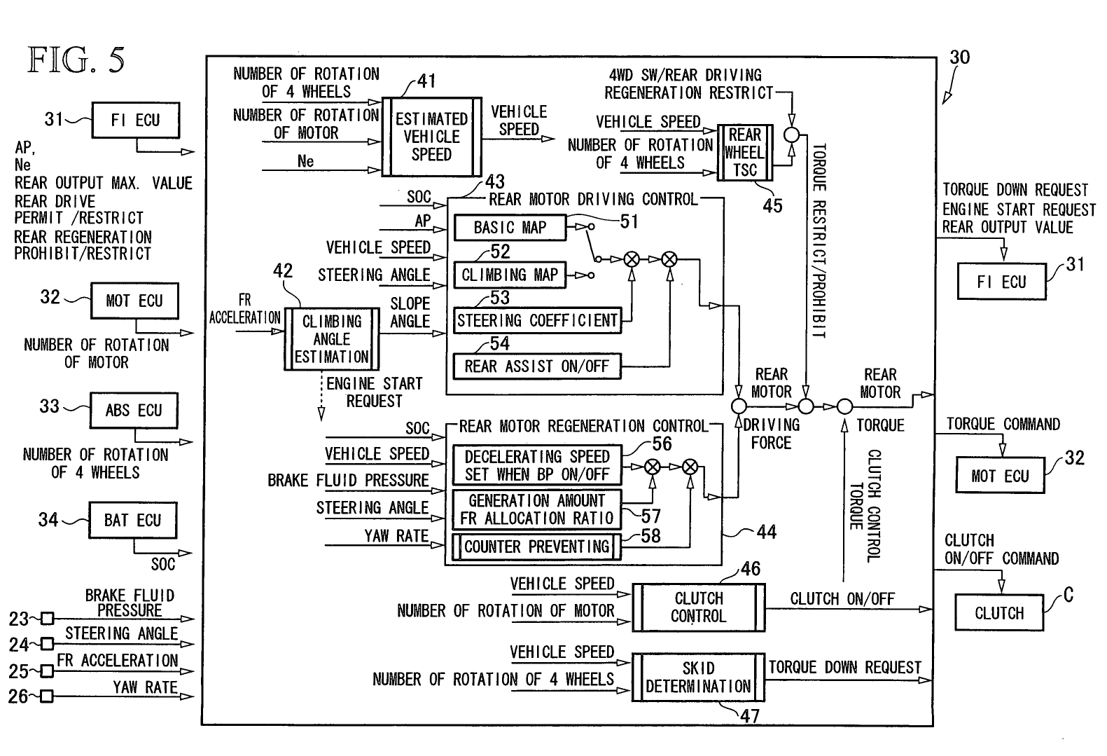

The motor M1 and M2 are controlled by a power drive unit (PDU) 2 in response to a control command from a motor ECU 32 (see FIG. 5) as a motor control unit.

A high-voltage nickel hydrogen battery (storage battery) 7 is connected to the power drive unit 2 for sending or receiving electrical power to and from the motor M1 and the motor M2. An auxiliary battery is connected to the battery 7 via a downverter that is a DC-DC converter, for operating various auxiliary devices.

The front wheels Wf that are driven by the engine E and the motor M2 have a front wheel brake (not shown), and the rear wheels Wr driven by the motor M1 have a rear wheel brake (not shown).

The engine E is a so-called an inline four-cylinder engine, and an electronic control throttle 12 is provided to an intake pipe 13 of the engine E. Furthermore, an accelerator position sensor for detecting how much a accelerator pedal (AP) (not shown) is depressed is connected to the engine ECU 31.

The engine ECU 31 calculates the amount of fuel injection from the depressed degree of the accelerator pedal or the like, and outputs a control signal dictating the amount of fuel injection to the electronic control throttle 12.

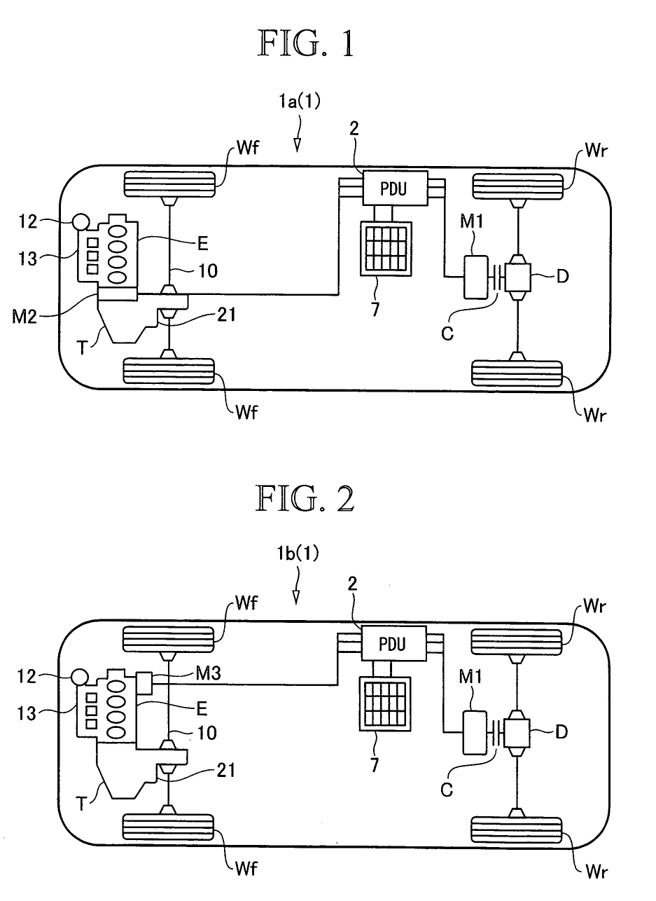

FIG. 2 is a schematic diagram of another exemplary hybrid vehicle 1b (1) to which the present invention is applied.

The hybrid vehicle 1b shown in FIG. 2 is a four-wheel drive as in the case in FIG. 1, and it differs from the hybrid vehicle 1a in that a motor M3 that functions as a generator is provided in the front wheels Wf side, instead of the motor M2 that functions as a traction motor. Thus, the front wheels (primary driving wheels) Wf of the vehicle 1b is driven only by the engine E, and the rear wheels (driven wheels) Wr of the vehicle 1b are driven by the motor M1.

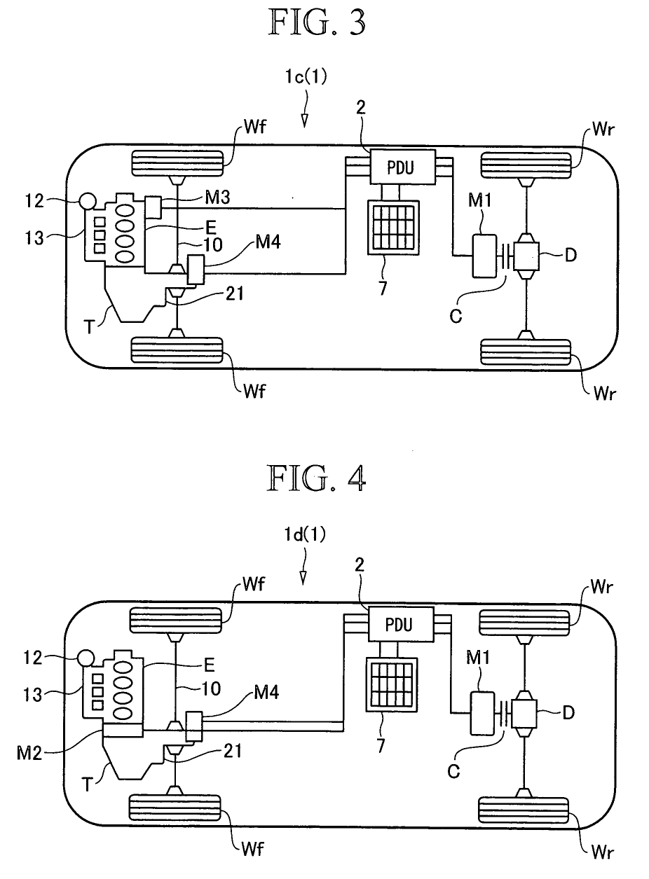

FIG. 3 is a schematic diagram of another exemplary hybrid vehicle 1c (1) to which the present invention is applied.

The hybrid vehicle 1c shown in FIG. 3 is a four-wheel drive as in the case in FIG. 1, and it differs from the hybrid vehicle 1a in that a motor M4 that functions as a traction motor and a motor M3 that functions as a generator are provided in the front wheels Wf side, instead of the motor M2 that functions as a traction motor. While the motor M2 shown in FIG. 1 is directly coupled to the engine E, the motor M4 shown in FIG. 3 is coupled to the front wheels Wf independently from the engine E. Thus, the front wheels (primary driving wheels) Wf of the vehicle 1c are driven by at least one of the engine E and the motor M4, and the rear wheels (driven wheels) Wr of the vehicle 1c are driven by the motor M1.

FIG. 4 is a schematic diagram of another exemplary hybrid vehicle 1d (1) to which the present invention is applied.

The hybrid vehicle 1d shown in FIG. 4 is a four-wheel drive as in the case in FIG. 1, and it differs from the hybrid vehicle 1a in that a motor M4 that functions as a traction motor is provided in the front wheels Wf side, in addition to the motor M2 that functions as a traction motor. While the motor M2 shown in FIG. 1 is directly coupled to the engine E, the motor M4 shown in FIG. 4 is coupled to the front wheels Wf independently from the engine E. Thus, the front wheels (primary driving wheels) Wf of the vehicle 1d are driven by at least one of the engine E and the motor M4, and the rear wheels (driven wheels) Wr of the vehicle 1d are driven by the motor M1.

The hybrid vehicles shown in FIGS. 1 to 4 have two traveling modes: an electric vehicle (EV) traveling mode in which the vehicle can be driven only by the traction motor M2 and/or M4, and an engine traveling mode in which the vehicle is driven by at least the engine E. Although the engine traveling mode can be classified into two modes: a mode in which the vehicle is driven only by the engine E, and another mode in which the vehicle is driven by the engine E and the motor M2 and/or M4, the two modes are collectively referred to as the engine traveling mode.

FIG. 5 is a block diagram of the ECU included in the hybrid vehicles shown in FIGS. 1 to 4.

As shown in FIG. 5, each of the hybrid vehicles 1a to 1d (hereinafter collectively referred to as “vehicle 1”) includes a management ECU 30 for globally controlling the vehicle, an FI-ECU (the engine ECU) 31 for controlling the engine E, an MOT-ECU (motor ECU) 32 for controlling at least one of the motors M1 to M4, an ABS-ECU 33 for controlling an anti-lock brake system (ABS) that prevents side slip of the vehicle 1, and a BAT-ECU (battery ECU) 34 for controlling the battery 7.

The management ECU 30 is connected to the engine ECU 31, the motor ECU 32, the ABS-ECU 33, and the battery ECU 34.

The management ECU 30 receives, from the engine ECU 31, the accelerator pedal depressed degree (AP), the number of revolutions Ne of the engine E (the number of rotations of the transmission T), a maximum output value of the rear motor M1, signals for permitting or restricting driving of the rear motor M1, signals for prohibiting or restricting regeneration by the rear motor M1.

Furthermore, the management ECU 30 receives the number of rotations of each of the motors M1 to M4 from the motor ECU 32. The management ECU 30 receives the number of rotations of each of the wheels Wf and Wr of the vehicle 1 from the ABS-ECU 33. The management ECU 30 receives the remaining capacity (SOC) of the battery 7 from the battery ECU 34.

In addition, the management ECU 30 receives brake fluid pressure detected by a brake fluid pressure sensor 23, the steering angle of a steering wheel 61 detected by a steering angle sensor 24, the front-rear acceleration (G) of the vehicle 1 detected by a front-rear acceleration (G) sensor 25, and yaw rate detected by a yaw rate sensor 26.

The management ECU 30 includes a vehicle speed estimation unit 41 that estimates the speed of the vehicle 1 (vehicle speed), a climbing angle estimation unit 42 that estimates the climbing angle of the road on which the vehicle 1 is traveling, a rear motor driving control unit 43 that executes the driving control of the rear motor M1, a rear motor regeneration control unit 44 that controls regeneration by the rear motor M1, a rear wheel traction control system (TCS) unit 45 that efficiently transmits the driving force of the rear wheels Wr to the road, a clutch control unit 46 that controls the starting clutch C, and a slip determination unit 47 that determines slip of the vehicle 1.

The vehicle speed estimation unit 41 receives the number of rotations of each of the wheels Wf and Wr, the number of rotations of the motors M1 to M4, and the number of revolutions Ne of the engine E. The vehicle speed estimation unit 41 estimates the speed of the vehicle 1 (vehicle speed) using the input values and outputs the estimated vehicle speed. The climbing angle estimation unit 42 receives the front-rear acceleration of the vehicle 1. The climbing angle estimation unit 42 estimates the climbing angle based on this input acceleration value, and outputs the slope angle of the road on which the vehicle is traveling and further outputs a start request of the engine E according to the estimated climbing angle.

The rear motor driving control unit 43 receives the remaining capacity (SOC) of the battery 7, the accelerator pedal depressed degree (AP), the vehicle speed estimated by the vehicle speed estimation unit 41, the steering angle, and the slope angle of the road estimated by the climbing angle estimation unit 42. The rear motor driving control unit 43 includes a basic map storing unit 51, a climbing map storing unit 52, a steering coefficient calculating unit 53, and a rear assist ON/OFF control unit 54.

The rear motor driving control unit 43 selects either one of a basic map and a climbing map corresponding to the received slope angle, and calculates the driving force of the rear motor M1 corresponding to the remaining capacity, the accelerator pedal depressed degree, and the vehicle speed according to the selected map. The climbing map is generated so that more driving force is allocated to the rear wheels compared to the basic map, and that greater driving force is therefore provided. By switching between the maps, the driving force that is responsive to traveling conditions of the vehicle can be supplied from the rear motor M1.

Furthermore, the steering coefficient calculating unit 53 calculates a steering coefficient according to the steering angle detected by the steering angle sensor 24. The driving force of the rear motor M1 while the vehicle 1 is turning is set by multiplying the driving force calculated using either one of the basic map and the climbing map by the steering coefficient.

The rear assist ON/OFF control unit 54 executes control according to the accelerator pedal depressed degree and the remaining capacity of the battery 7. When it is determined that an assist of the driving force by the rear motor M1 is required (when the rear assist is required to be turned on), the ratio corresponding to the driving force determined as required is multiplied by the driving force of the rear motor M1, and the resulting value is output from the rear motor driving control unit 43.

The rear motor regeneration control unit 44 receives the remaining capacity (SOC) of the battery 7, the vehicle speed, the brake fluid pressure, the steering angle, and the yaw rate. The rear motor regeneration control unit 44 includes a decelerating speed set unit when the brake pedal is ON/OFF 56, a regenerated power front-rear allocation ratio calculating unit 57, and a counter preventing unit 58. The decelerating speed set unit when the brake pedal is ON/OFF 56 sets a deceleration according to whether the brake pedal is depressed or not. Furthermore, the regenerated power front-rear allocation ratio calculating unit 57 calculates the allocation ratio between at least one of the front-wheel motors M2 to M4 and the rear-wheel motor M1 according to the vehicle speed, the steering angle, and the yaw rate. This allocation ratio for the rear wheels is multiplied by the regenerated power that corresponds to the deceleration. The above regenerated power is multiplied by the coefficient calculated by the counter preventing unit 58, which is outputs from the rear motor regeneration control unit 44. The counter preventing unit 58 prevents the steering wheel 61 that is a steering device from entering into a counter state. This will be described later.

The rear wheel TCS unit 45 receives the vehicle speed and the number of rotations of each of the wheels Wf and Wr. Based on these input values, the rear wheel TCS unit 45 outputs the driving force of the rear motor M1. The output driving force is adjusted so that the output driving force becomes equal to or lower than the driving/regeneration restriction command for the rear motor M1. This value is used as a torque restricting/prohibiting value. The rear motor driving force is obtained by adding a respective output values from the rear motor driving control unit 43 and the rear motor regeneration control unit 44, which is added to the above-mentioned torque restricting/prohibiting value.

The clutch control unit 46 receives the vehicle speed and the number of rotations of the motor M1. Based on these input values, the clutch control unit 46 controls turning on and off of the starting clutch C. In other words, by disconnecting the starting clutch C when the vehicle speed or the number of rotations of the motor M1 reaches a predetermined value, dragging of the rear motor M1 can be prevented, thereby protecting the rear motor M1 from being operated at an excessively high rotation number. The clutch control unit 46 outputs a clutch ON/OFF signal and a torque for controlling the clutch. This torque for controlling the clutch is added to the above-described rear motor driving force.

The slip determination unit 47 receives the vehicle speed and the number of rotations of each of the wheels Wf and Wr. The slip determination unit 47 determines whether or not the vehicle 1 is slipping based on these input values, and outputs a torque down request signal for the rear motor M1 based on this determination.

The management ECU 30 outputs, to the engine ECU 31, the torque down request, an engine start request, and the output value from the rear motor M1. Furthermore, the management ECU 30 outputs a torque command for the rear motor M1 to the motor ECU 32, and outputs an ON/OFF command for the starting clutch to the starting clutch C.

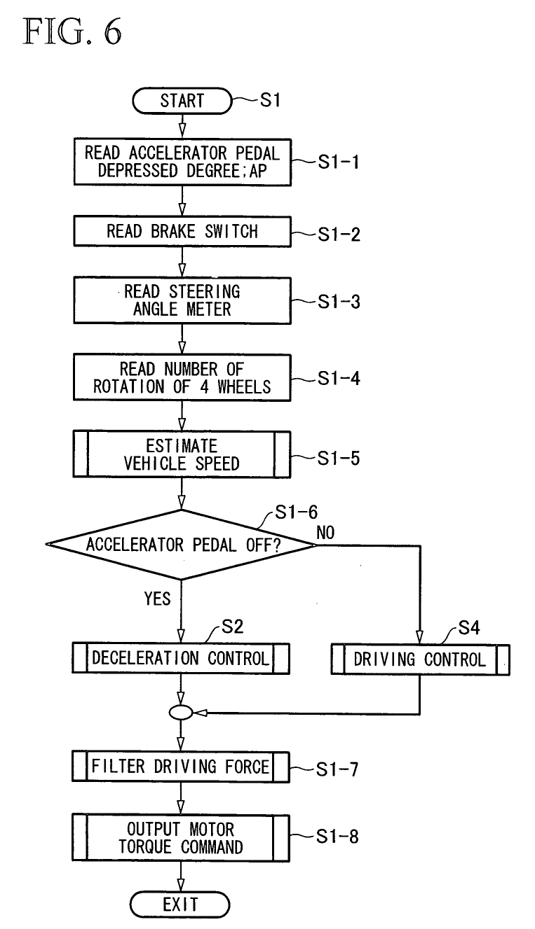

FIG. 6 is a flowchart of a main control executed by the hybrid vehicles according to the embodiments of the present invention. First, as shown in FIG. 6, the signal AP from the accelerator pedal depressed degree sensor is read to the management ECU 30 in step S1-1. Then, an ON/OFF signal for the brake switch, the steering angle detected by the steering angle sensor 24, and a rotational speed of each of the wheels Wf and Wr are read to the management ECU 30, in step S1-2, step S1-3, and step S1-4, respectively.

In step S11-5, the vehicle speed of the vehicle is estimated by the vehicle speed estimation unit 41 from the rotational speed of each of the wheels Wf and Wr or other signals relating to the rotation, including the number of rotation of the motors M1 to M4, the number of revolutions of the engine Ne, or the like.

In step S1-6, it is determined whether or not the accelerator pedal is released based on the accelerator pedal depressed degree determined in step S1-1. When the result is YES (i.e., the accelerator pedal is released), the flow proceeds to step S2 in which a deceleration control of the vehicle 1 is executed.

When the result is NO (i.e., the accelerator pedal is being depressed), the flow proceeds to step S4 in which a driving control of the vehicle 1 is executed.

After either the deceleration control or the driving control is executed in step S2 or S4, the flow proceeds to step S1-7, in which a driving force filtering control is executed. Specifically, the driving force command of the rear motor output in step S2 or S4 is adjusted to smooth the variation in the driving force command in step S1-7, and the smoothed value is again set as a target driving force. In step S1-8, the target driving force determined in step S1-7 is output to the motor ECU 32 as a motor torque command. The motor ECU 32 controls the motors M1 to M4 based on the output motor torque command.

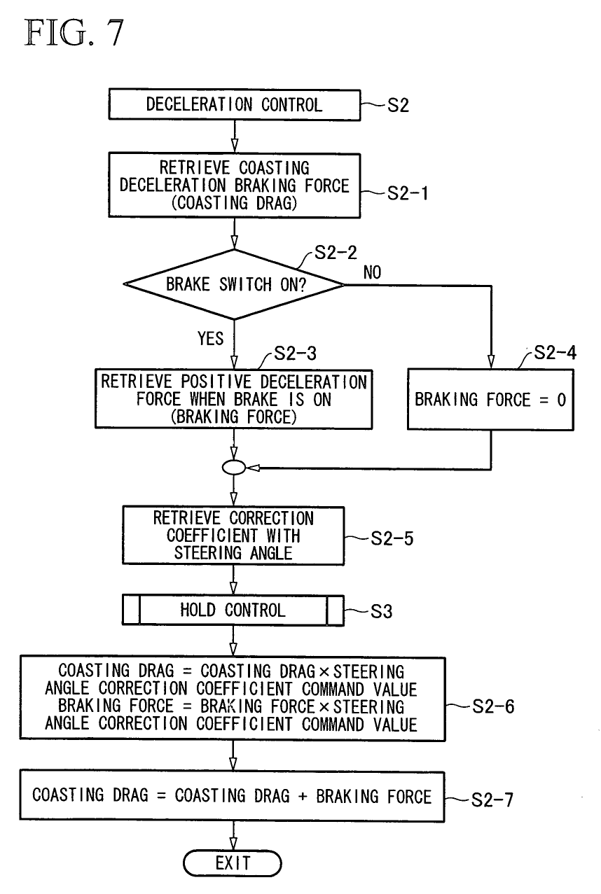

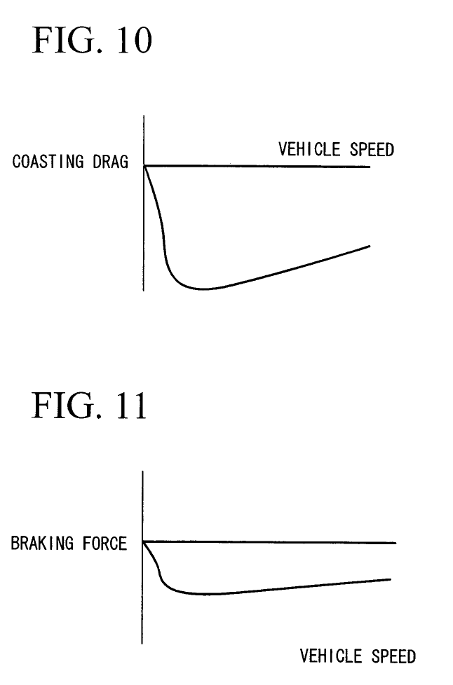

FIG. 7 is a flowchart of the deceleration control shown in FIG. 6. As shown in FIG. 7, in step S2-1, a natural deceleration force (a coasting drag) of the vehicle during coasting deceleration is retrieved by searching in a map (see FIG. 10) based on the vehicle speed estimated by step S1-5. FIG. 10 is a graph illustrating the relationship between the vehicle speed and the coasting drag. As shown in FIG. 10, the coasting drag significantly increases when the vehicle speed is increased from zero, and gradually decreases when the vehicle speed is increased further.

In step S2-2, it is determined whether or not the brake switch is turned on based on the signal of the brake switch that has been detected in step S1-2. When the result is YES (i.e., the brake switch is being depressed), the flow proceeds to step S2-3, and when the result is NO (i.e., the brake switch is released), the flow proceeds to step S2-4.

In step S2-3, a positive deceleration force (braking force) that is to be provided to the vehicle 1 when the brake is depressed is retrieved by searching in a map (see FIG. 11) based on the vehicle speed estimated in step S1-5. FIG. 11 is a graph illustrating the relationship between the vehicle speed and the braking force. As shown in FIG. 11 the braking force increases when the vehicle speed is increased from zero, and gradually decreases when the vehicle speed is increased further. After step S2-3, the flow proceeds to step S2-5.

In contrast, the braking force is set to zero in step S2-4 since the brake switch is not depressed. The process then proceeds to step S2-5.

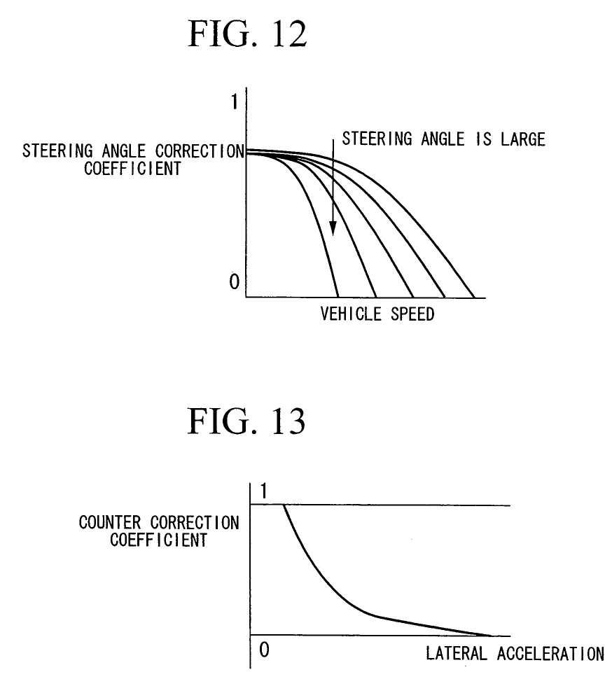

In step S2-5, based on the steering angle that is output in step S11-3, the correction coefficient corresponding to the steering angle retrieved by searching in a map (see FIG. 12). FIG. 12 is a graph illustrating the relationship between the vehicle speed and the steering angle correction coefficient. As shown in FIG. 12, the steering angle correction coefficient is set to 1 when the vehicle speed is zero. As the vehicle speed increases to reach a predetermined value or higher, the steering angle correction coefficient decreases. The steering angle correction coefficient becomes zero when the vehicle speed increases further.

Furthermore, as shown in FIG. 12, the higher the steering angle is, the smaller value the steering angle correction coefficient is set to at the same vehicle speed.

The map shown in FIG. 12 is stored in the counter preventing unit 58 in the rear motor regeneration control unit 44.

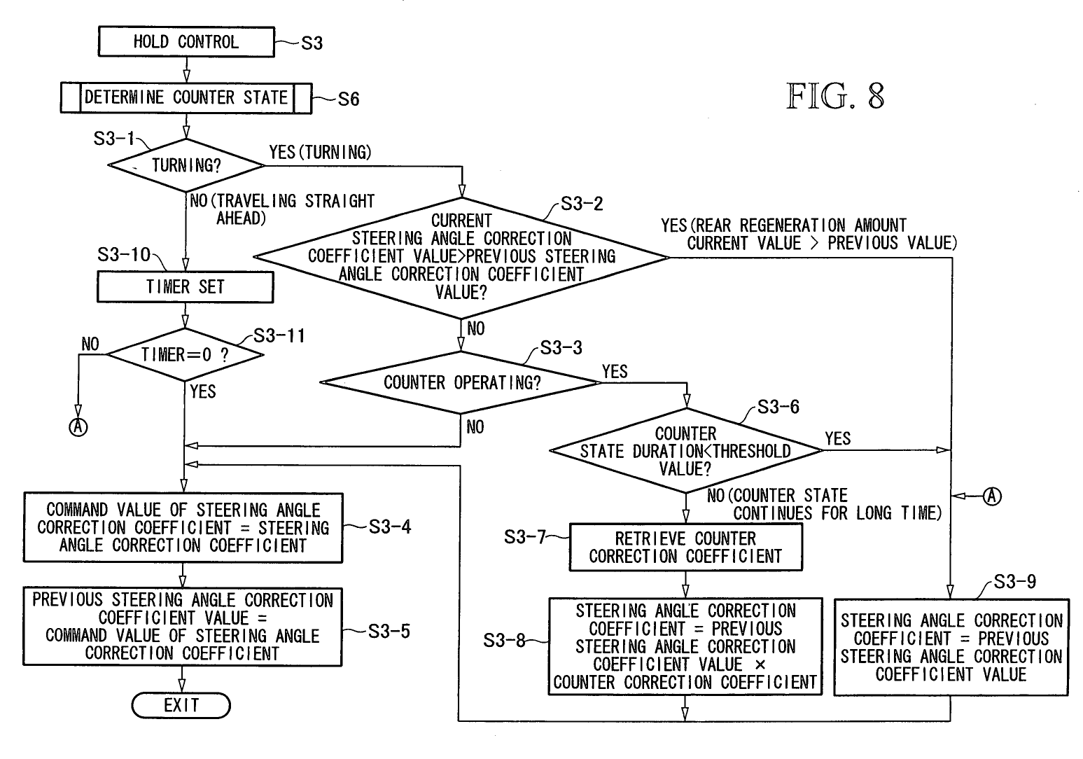

After step S2-5, a regenerated power hold control for the rear motor M1 (see FIG. 8) is executed as shown in step S3, and the flow proceeds to the step S2-6. In step S2-6, the coasting deceleration braking force retrieved in step S2-1 is multiplied by the command value of the steering angle correction coefficient determined in the hold control in step S3, and the resulting value is output as a coasting deceleration braking force. Similarly, the braking force retrieved or set in step S2-3 or S2-4 is multiplied by the command value of the steering angle correction coefficient, and the resulting value is output as a coasting deceleration braking force. In step S2-7, the coasting drag and the braking force obtained in step S2-6 are added, and the resulting value is output as a final target driving force for the rear motor M1.

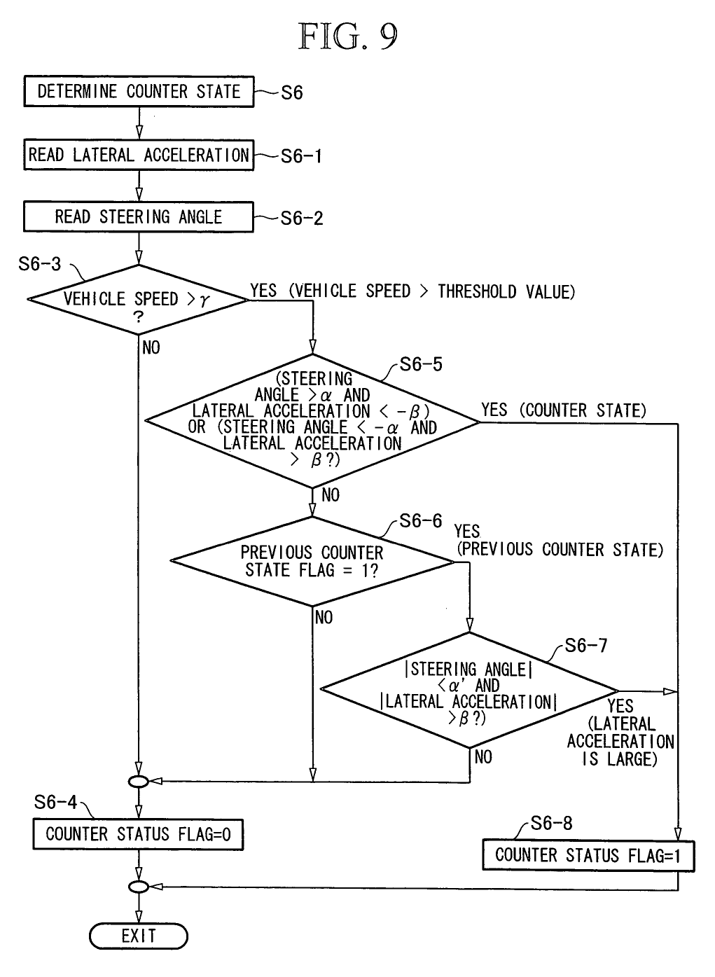

FIG. 8 is a flowchart of a rear regeneration allocation ratio hold control shown in FIG. 7. As shown in FIG. 8, in the hold control in step S3, after a counter state determination (see FIG. 9) is executed in step S6, the flow proceeds to step S3-1.

In step S3-1, it is determined whether or not the vehicle is turning, and when the result is YES (i.e., the vehicle is turning), the flow proceeds to step S3-2. When the result is NO (i.e., the vehicle is traveling straight ahead), the flow proceeds to step S3-10. In step S3-10, a timer is activated. In step S3-11, it is determined whether or not the value of the timer is zero. When the result is YES, the flow proceeds to step S3-4. In contrast, the flow proceeds to step S3-9 when the result is NO.

In step S3-4, the command value of the steering angle correction coefficient is set as the steering angle correction coefficient. In step S3-5, the previous value of the steering angle correction coefficient is replaced with the command value of the steering angle correction coefficient, and then the process ends.

In contrast, in step S3-2, it is determined whether or not the current value of the steering angle correction coefficient is greater than the previous value, i.e., the current value of the regenerated power by the rear motor M1 is greater than the previous value. When the result is YES, the flow proceeds to step S3-9. When the result is NO, the flow proceeds to step S3-3. In step S3-9, the steering angle correction coefficient is set to the previous value of the steering angle correction coefficient, and the flow proceeds to step S3-4 to execute the above-described process.

In step S3-3, it is determined whether or not a counter operation is being carried out based on the counter operation state signal output in step S6. When the result is YES, the flow proceeds to step S3-6. In contrast, the flow proceeds to step S3-4 when the result is NO. In step S3-6, it is determined whether or not the measured duration of the counter state is greater than a threshold. When the result is YES, the flow proceeds to step S3-9. In contrast, the flow proceeds to step S3-7 when the result is NO.

In step S3-7, a counter correction coefficient is retrieved by searching in a map (see FIG. 13). FIG. 13 is a graph illustrating the relationship between the lateral acceleration and the counter correction coefficient. As shown in FIG. 13, the counter correction coefficient is set to 1 when the lateral acceleration of the vehicle is zero. The counter correction coefficient decreases when the lateral acceleration exceeds a predetermined value, and the counter correction coefficient becomes zero when the lateral acceleration reaches another predetermined value that is greater than the predetermined value.

In step S3-8, the steering angle correction coefficient is determined by multiplying the previous value of the steering angle correction coefficient by the counter correction coefficient.

As described previously, when the steering angle is decreased, the regenerated power by the rear motor M1 is set to a regenerated power at a maximum steering angle. By this, the braking force generated by the rear motor M1 can be maintained to a constant. Therefore, a turning motion can be carried out without causing discomfort to the driver, thereby enhancing maneuverability while improving fuel efficiency.

FIG. 9 is a flowchart of the counter state determination control shown in FIG. 8. As shown in FIG. 9, in step S6-1, the lateral acceleration (the yaw rate) of the vehicle 1 is read from the yaw rate sensor 26. In step S6-2, a detected value of the steering angle is read from the steering angle sensor 24. When the vehicle acceleration exceeds a threshold y in step S6-3, the flow proceeds to step S6-5; otherwise the flow proceeds to step S6-4.

In step S6-4, a counter flag is set to “0” since it can be determined as not being in a counter state.

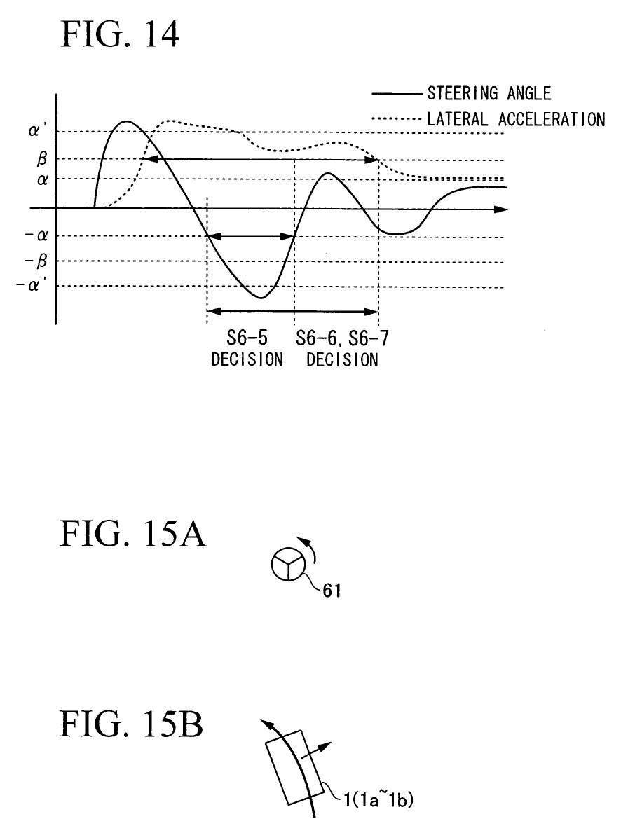

In step S6-5, it is determined that either one of the following two conditions holds true: (i) the steering angle is greater than a threshold a and the lateral acceleration is smaller than −β; or (2) the steering angle is smaller than a threshold −α and the lateral acceleration is greater than threshold β by using the steering angle and the lateral acceleration detected in steps S6-1 and S6-2. If so, the flow proceeds to step S6-8. Otherwise, the flow proceeds to step S6-6 (see FIGS. 14 and 15). All of α, β, and γ are positive values.

FIG. 14 is graph illustrating the change of the lateral acceleration of the vehicle and the steering angle over time. FIGS. 15A and 15B are diagrams illustrating examples of the steering angle and the lateral acceleration. As shown FIG. 15A, in this embodiment, a positive value of steering angle is assumed as the counterclockwise direction of the steering wheel 61, and a positive value of lateral acceleration is assumed as right side with respect to the direction in which the vehicle travels.

Accordingly, when the steering angle of the steering wheel 61 is greater than the threshold a as determined in step S6-5 means that the steering wheel 61 is turned right. In this case, when the lateral acceleration of the vehicle 1 is greater than the threshold p, the lateral acceleration of the vehicle 1 is a positive values (in right direction). Thus, it is determined as being in the counter state. This holds true for the other case shown in step S6-5.

When the counter state flag is “1” in the previous control cycle in step S6-6, the flow proceeds to step S6-7. Otherwise, the flow proceeds to step S6-4. When the absolute value of the steering angle is greater than threshold α′ (which is greater than a) and the absolute value of the lateral acceleration is greater than a threshold β in step S6-7, the flow proceeds to step S6-8; otherwise, proceeds to step S6-4. In step S6-8, a counter flag is set to “1” since it can be determined that the counter state has not been eliminated.

As described previously, since control is carried out by the correction coefficients being searched by determining presence or absence of a counter state, as shown in step S3-7, and multiplying it by the regenerated power by the rear motor M1, braking force by the rear motor M1 can be suppressed. Accordingly, the driving force provided by the rear motor M1 can be utilized for a turning motion in a most effective manner, and the vehicle is controlled to promptly exit from a counter state, thereby further enhancing maneuverability.

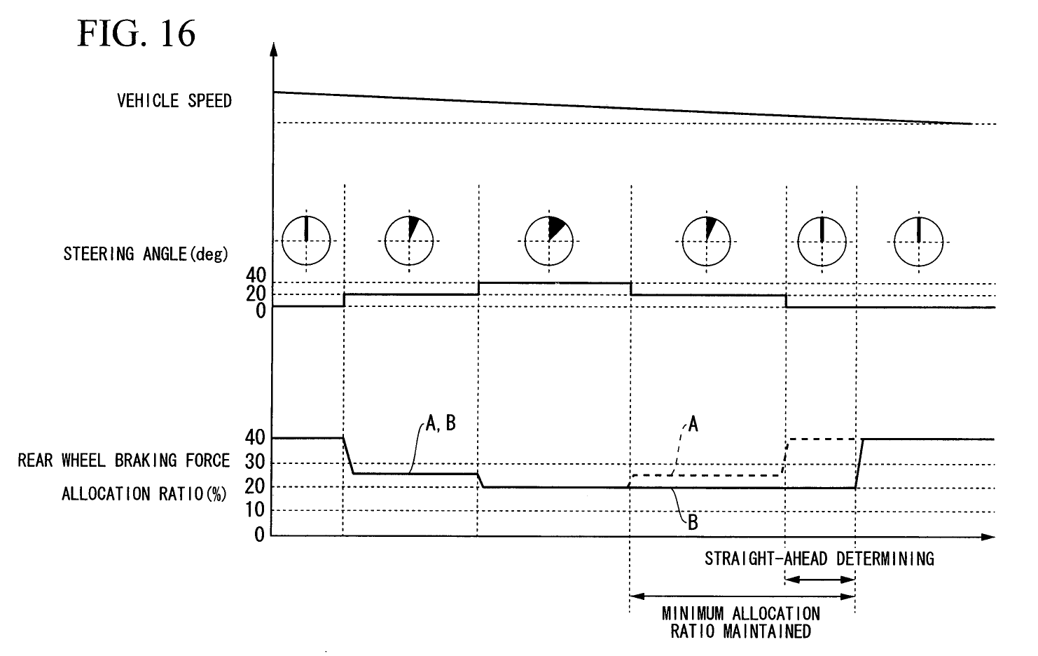

FIG. 16 is graph illustrating the change of the vehicle speed, the steering angle, and the ratio to allocate braking force to the rear wheels over time. As shown in FIG. 16, when the vehicle speed is reduced and regeneration by the rear motor M1 is available, the regenerated power is reduced according to the steering angle, i.e., the ratio to allocate braking force to the rear wheels is reduced, thereby improving maneuverability (as shown by the line A). In addition, the regenerated power is set to a regenerated power at a maximum steering angle and this regenerated power is fixed until the vehicle begins to travel straight ahead, thereby further enhancing the driving stability (as shown by the line B).

While preferred embodiments of the invention have been described and illustrated above, it should be understood that these are examples of the invention and are not to be considered as limiting. For example, while a mechanical oil pump is used in the above embodiments, other types of pump, such as an electric oil pump, may be used. Additions, omissions, substitutions, and other modifications can be made without departing from the spirit or scope of the present invention. Accordingly, the invention is not to be considered as being limited by the foregoing description, and is only limited by the scope of the appended claims.

1. A control apparatus for a hybrid vehicle that comprises front and rear wheels, a battery, a first driving source that drives one of the front and the rear wheels, a second driving source that drives the other of the front and the rear wheels, the second driving source being operated by an electric energy stored in an electricity storing unit, an electric motor that collects a kinetic energy during deceleration of the vehicle to charge the electricity storing unit, comprising:
a deceleration state detecting unit that detects a deceleration state of the vehicle;
a turning state detecting unit that detects a turning state of the vehicle,
wherein a regenerated power by the electric motor is calculated according to the deceleration state detected by the deceleration state detecting unit and the turning state detected by the turning state detecting unit, and the electric motor is controlled according to the regenerated power.

2. A control apparatus for a hybrid vehicle according to claim 1, wherein the vehicle comprises a steering unit, wherein the turning state detecting unit comprises a steering angle detecting unit that detects a steering angle of the steering unit, and wherein the regenerated power by the electric motor is decreased as the steering angle detected by the steering angle detecting unit is increased to the direction to which the steering angle rotates.

3. A control apparatus for a hybrid vehicle according to claim 2, wherein the electric motor drives the rear wheels, and the regenerated power by the electric motor is set to zero when the steering angle detected by the steering angle detecting unit is increased to a predetermined value or greater.

4. A control apparatus for a hybrid vehicle according to claim 2, wherein when the steering angle is decreased after the regenerated power by the electric motor is decreased with an increase in the steering angle detected by the steering angle detecting unit, the regenerated power by the electric motor is set to a regenerated power at a maximum detected steering angle.

5. A control apparatus for a hybrid vehicle according to claim 4, wherein when the vehicle begins to travel straight ahead from a turn, the regenerated power by the electric motor is no more set to the regenerated power at the maximum detected steering angle.

6. A control apparatus for a hybrid vehicle according to claim 1, wherein the turning state detecting unit determines the turning state of the vehicle based on the steering angle and an operation direction of the steering unit and a yaw rate.
